(19) United States
(12) Patent Application Publication
(10) Pub. No.: US 2011/0231219 A1
(43) Pub. Date: Sep. 22, 2011

(54) METHOD AND SYSTEM FOR MEASURING KNOWLEDGE RISK AND ASSESSING MATURITY

(75) Inventor: Ravi Agarwal, Wakad (IN)

(73) Assignee: Infosys Technologies Limited, Bangalore (IN)

(21) Appl. No.: 12/813,704

(22) Filed: Jun. 11, 2010

(30) Foreign Application Priority Data
Mar. 19, 2010 (IN) 723/CHE/2010

(51) Int. Cl. G06Q 10/00; G06Q 90/00

(52) U.S. Cl. 705/7.17; 705/500

(57) ABSTRACT

The present invention provides a method and system for evaluating the knowledge risk maturity (KRM) of a team executing a project and to check the progress of the project. A method for quantifying knowledge risk maturity coefficient (KRMC) of the team and a method to identify the skills required by the team members to execute the project for different time frames are also provided. A KRMC trend is determined based on KRMC determined at different time instances. A skill requirement trend is also determined based on skills required by the team to execute the project at different time instances. By comparing the two trends, a plurality of KRM are evaluated for each time frame. On the basis of the KRMC trend and KRM, corrective measures are taken to enhance the KRMC to its maximum value. This in turn ensures that skill requirements of a project are met.

### BACKGROUND OF THE INVENTION

Typically, organizations maintain a workforce and other resources for executing various projects. In most of the cases, an organization selects one or more employees from the workforce to form a team for executing a project. Usually, the team is managed by a project manager for the successful accomplishment of the project. The project manager allocates various tasks associated with the project to the members of the team and constantly monitors their performance during the project lifecycle.

At present, a project manager assesses the team's performance based on the quality delivered by the team, the productivity of the team, etc. An important parameter for assessing the team's performance is skill set required by the team for executing a project at any instance of time.

The skill-set requirement for executing a project varies with respect to the lifecycle of a typical project. The variation in the skill-set requirement may be due to the expansion in the project, iteration with in the team, or modification in a predefined project plan. The project manager can modify the team size, conduct training programs, or can modify the predefined project plan to meet the skills required by the team to execute the project. It is usual that as the project progresses, the project manager need to assess the skill level of the team and compare it with the skill-set requirement of the project. This is critical to make sure that the project proceeds smoothly and the end objectives of the project are achieved. However, there is no such system or method that enables a person to asses the skill requirements of a team vis-à-vis the achieved skill set. Due to the lack of such methods, it becomes difficult to get an approval from stakeholders for team modification or for modification in the predefined project plan.

The corrective measures, as discussed above, may be useful only for a short-term project involving a small team. However, these corrective measures do not give efficient output in the scenarios when either the project spans over a long duration or the project involves a large team, as the project manager neither accounts for the skills required for executing the project successfully nor the skills possessed by the team. In addition to this, the corrective measures taken by the project manager involves his/her personal judgment and subjectivity.

Hence, there is a need for a method and system that enables the project manager to assess the skill-set requirement objectively, thereby helping the project manager to take precise corrective measures to meet the skill-set requirement and to ensure a smooth execution of the project, enhancing the quality and productivity of the project.

### BRIEF SUMMARY OF THE INVENTION

The present invention provides a method and system for evaluating a knowledge risk maturity (KRM) of a team on the basis of knowledge risk maturity coefficient (KRMC) and skill sets required by team members to accomplish a project.

The present invention provides a method for evaluating KRM of a team executing a project. To a project manager, the KRM of the team is an indicator of the skill-set requirement for the project. With the help of the indicator, the project manager may determine corrective measures for ensuring smooth execution of the project.

The present invention provides a method for calculating KRMC at any instance during the execution of the project. The KRMC is calculated using the number of skills required by each team member and the existing skill value for them.

KRM is a comparative measure of skills required by the team to execute the project at any instance of time. KRMC trend is an indicative of smooth progress of the project. The KRMC trend is identified for defined time duration, using KRMCs at different instances of time.

According to an embodiment of the present invention, a KRM system includes a calculator for calculating the KRMC and an analyzer for analyzing the trends of the number of skills required by the team to execute the project at different instances of time. A trend module compares the KRMC received from the calculator and identifies the KRMC trend to a comparator and a display unit. Also, the comparator receives the skills requirement trends from the analyzer. The comparator then compares the KRMC trend and the skills requirement trends. The comparator identifies a plurality of KRM for all time instances to the display unit. Thereafter, the display unit displays the KRMC trend, skill requirement trends, and the plurality of KRM in a matrix format. Based on the comparative display of the KRMC trend, the skill requirement trends, and the plurality of KRM, appropriate corrective measures can thus be taken to ensure the smooth execution of the project.

An advantage of the present invention is that the KRM system provides the KRM of a team that is executing a project on the basis of which corrective measures are taken for the smooth execution of the project. This in turn can ensure that a high-quality output is achieved from the project.

Another advantage of the present invention is the use of KRMC as an absolute number at any instance of time to determine the risk associated with the project at that instance of time.

### BRIEF DESCRIPTION OF THE DRAWINGS

Various embodiments of the invention will hereinafter be described in conjunction with the appended drawings provided to illustrate, and not to limit, the invention, wherein like designations denote like elements, and in which:

FIG. 1 is an exemplary knowledge risk maturity (KRM) system in accordance with an embodiment of the invention;

FIG. 2 illustrates a flowchart for a method for evaluating team KRM at different instances of time and knowledge risk maturity coefficient (KRMC) trend for a defined duration of time, in accordance with an embodiment of the invention; and

FIG. 3 illustrates a flowchart of a method for calculating KRMC at an instance of time, of a team executing a project, in accordance with an embodiment of the invention.

### DETAILED DESCRIPTION

In a typical organization, one or more employees from the workforce are grouped to form a team for executing a project. The team may be managed by a project manager for the successful accomplishment of the project. The project manager manages the team performance and ensures a high quality output. Moreover, the project manager needs to keep a periodical check on the team performance and take corrective measures accordingly.

The invention describes a method, system, and computer program product for evaluating a knowledge risk maturity coefficient (KRMC) and a knowledge risk maturity (KRM) of a team executing a project. The knowledge level of the team is managed on the basis of the evaluated KRMC and a plurality of KRM. The knowledge level of the team should be managed in ways that enhance the KRMC to its maximum value to ensure a smooth execution of the project.

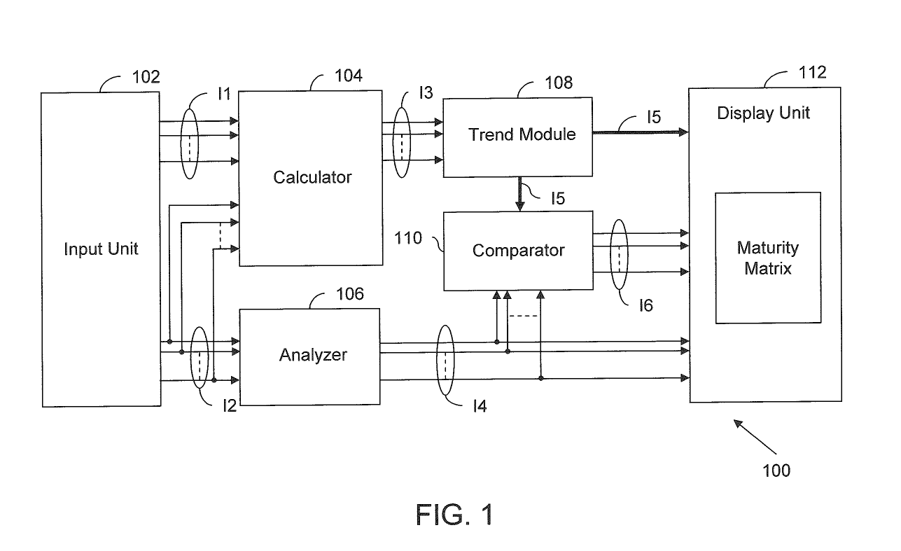

FIG. 1 is an exemplary KRM system 100 in accordance with an embodiment of the invention. KRM system 100 includes an input unit 102, a calculator 104, an analyzer 106, a trend module 108, a comparator 110, and a display unit 112.

One or more team members or any person associated with the project provides inputs to input unit 102. Calculator 104 receives inputs I1 and I2 for different instances of time t such as t₁, t₂ . . . tₙ from input unit 102. Inputs I1 is an existing skill value corresponding to the skills “possessed” by the team and inputs I2 is the number of skills “required” by the team to execute the project. Calculator 104 calculates KRMC based on the received inputs I1 and I2. Analyzer 106 also receives input I2 from input unit 102 for same instances of time t. Analyzer 106 analyses the skill-requirement trends I4 for various “time frames” within a defined duration of time T. The “time frame” is the difference between two consecutive instances of time.

Trend module 108 receives input 13 from calculator 104. Input 13 is KRMC for instances of time t. Trend module 108 identifies a KRMC trend I5 for the defined duration of time T. T is the combination of instances of time t (i.e. T=t₁+t₂+ . . . +tₙ) for which inputs I1 and I2 are provided to calculator 104 and analyzer 106. Comparator 110 receives inputs I4 and I5 from analyzer 106 and trend module 108, respectively. Comparator 110 provides a plurality of KRM I6 to display unit 112 for the same instances of time t for which inputs I1 and I2 are given to calculator 104 and analyzer 106. Display unit 112 also receives inputs I4 and I5 from analyzer 106 and trend module 108, respectively. Display unit 112 displays the data received from analyzer 106, trend module 108, and comparator 110 in the form of a matrix. Based on the trends displayed in the matrix by display unit 112, the project manager analyzes the KRM of the team for instances of time t and can assess the progress of the project for time duration T. Corrective measures may then be taken by the project manager to enhance the KRM of the project.

In various embodiments of the invention, the modules of KRM system 100 may be implemented in the form of software, hardware, firmware, or combinations thereof.

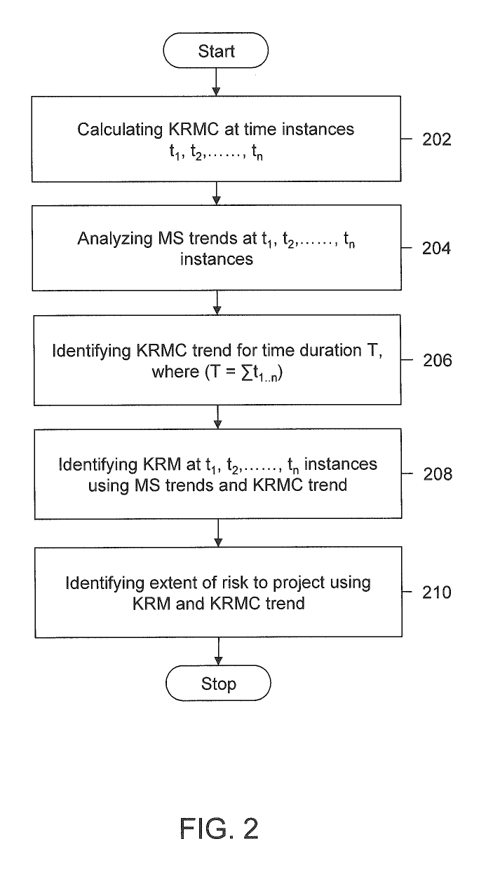

FIG. 2 is a flowchart illustrating a method for evaluating KRM at different instances of time t such as t₁, t₂ . . . tₙ and identifying KRMC trend for a defined time duration T, in accordance with an embodiment of the invention.

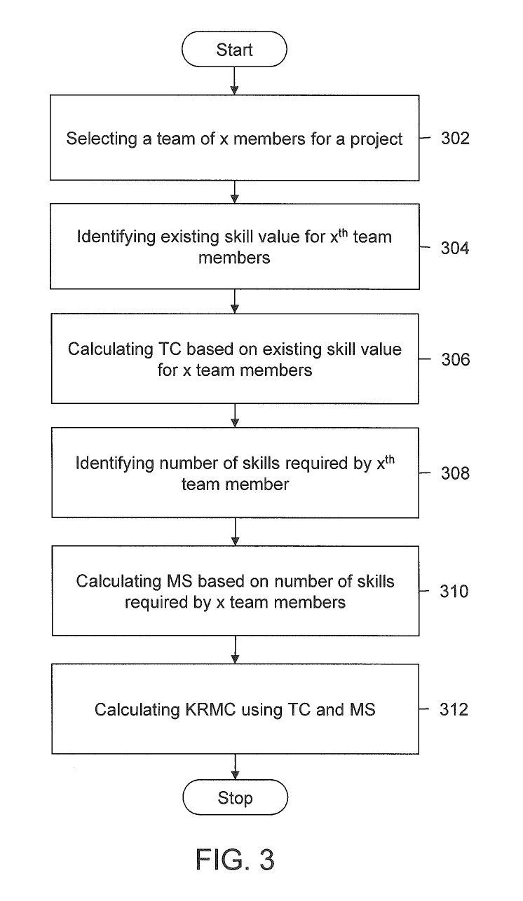

At 202, KRMC are calculated for instances of time t such as t₁, t₂ . . . tₙ. KRMC is a measure of knowledge requirement of a team for the project being executed by it. The method for calculating KRMC is described in detail in FIG. 3.

At 204, the trends for skill set required (referred to as ΣMS) by the team to execute the project are identified for same instances of time t. ΣMS depicts a collection of number of skills required by the team members. The ΣMS trends may indicate that the number of skills required by the team to execute the project is increasing, decreasing, or is constant. The ΣMS trend for any given time frame is analyzed by comparing the number of skills required at that instance with the number of skill required at a previous instance of time.

At 206, KRMC trend is determined for KRMC calculated at 202 for t. The KRMC trend is determined for duration of time T, where T is

T=Σt (i.e. T=t₁+t₂+ . . . +tₙ)

At 208, a plurality of KRM is evaluated for same instances of time t on the basis of the ΣMS trends and the KRMC trend. A KRM for any instance of time is identified by comparing the KRMC trend with the ΣMS trend at the same instance of time.

At 210, the extent of risk associated with the project is evaluated by using the plurality of KRM for different instances of time t and the KRMC trend for the time duration T. Corrective measures may be taken by the project manager according to the extent of risk associated with the project which is evaluated on the basis of plurality of KRM for t and KRMC trend for time duration T. The corrective measures taken by the project manager should be directed toward enhancing KRMC to its maximum value for the next instance of time, i.e., for tₙ₊₁. For an ideal situation, KRMC has a value of 1.

The following exemplary embodiment illustrates the evaluation of plurality of KRM on the basis of the KRMC trend and ΣMS trends.

In the exemplary embodiment, a team is assumed to be executing a project and the duration of the project is taken to be one year. The number of skills initially required by the team for executing the project is denoted by MSᵢ. After the first two months of execution, the project manager wants to evaluate the KRM of the team and take corrective measures to ensure high-quality output for the project. KRMC may be calculated for four different instances of time, i.e., for every fifteen days, t₁, t₂ . . . tₙ, of the total time duration, i.e., the first two months T. The method for calculating a KRMC is illustrated in FIG. 3. By comparing these four KRMCs, a KRMC trend is identified for the time duration of the first two months. The number of skills required per team member at first instance of time is identified. By combining the number of skills required for each member, the number of skills required by the team (MS₁) is identified for the first instance of time, i.e., after first fifteen days of the total time duration. Similarly MS₂, MS₃, and MS₄ are identified after second, third, and fourth duration of fifteen days of the total time duration, respectively. By comparing each of the MS of an instance with the MS of the previous instance, a skill requirement (ΣMS) trend for that time frame is analyzed. For example, if MSᵢ>MS₁, ΣMS will have a downward trend for the time frame of tᵢ to tₙ.

KRM at the first instance of time is identified by comparing the KRMC trend with ΣMS trend at the first instance of time. Similarly, the plurality of KRM is determined at all the four instances of time. The team is evaluated and corrective measures are taken on the basis of KRM at each instance of time and the KRMC trend for the first two months.

There will be more than one scenario for which KRM of the team can be evaluated and consecutively corrective measures can be taken. Some of those scenarios are explained below:

Case 1: When KRMC trend is downward (↓) for the first two months:

a. If ΣMS trend is constant ( [symbol] ) for a time frame within these two months, KRM decreases (↓). KRM decreases (↓) with KRMC trend going downward (↓) even when equal number of skills (ΣMS) is required; this indicates that the project has moderate risk, and it is recommended to enhance the existing skill value for each team member.
b. If ΣMS trend is in the upward (↑) direction for a time frame within these two months, KRM again shows a downward (↓) trend. KRM decreases (↓) and KRMC trend is going downward (↓) when more number of skills (ΣMS) is required; this indicates that the project has less risk as compared with risk indicated in Case 1(a), and it is recommended to enhance the existing skill value for the team, or reduce the skill requirement if possible.
c. If ΣMS trend is in the downward (↓) direction for a time frame within these two months, KRM decreases (↓). KRM decreases (↓) and KRMC trend is going down (↓) even when less number of skills is required; this indicates that the project has higher risk as compared with the risk indicated in Case 1 (a & b), and there is an aggressive need for enhancing the existing skill value for the team.

For the above mentioned Case 1, it may be concluded that the project has risk whenever KRMC trend goes downward (↓) and KRM decreases (↓). However, the extent of risk and the corrective measures are determined on the basis of ΣMS trend.

Case 2: When KRMC trend is upward (↑) for the first two months:

a. If ΣMS trend is constant ( [symbol] ) for a time frame within these two months, KRM increases (↑). The KRMC trend goes in the upward (↑) direction and KRM increases (↑) when an equal number of skills (ΣMS) is required; this indicates that the project has less risk as compared with risk indicated in Case 1. Conclusion for this scenario could be that the team is performing well, but still needs improvement.
b. If ΣMS trend is in the upward (↑) direction for a time frame within these two months, KRM increases (↑). The KRMC trend goes in the upward direction (↑) and KRM increases (↑) even when more number of skills (ΣMS) is required; this indicates that the project has less risk as compared with risk indicated in Case 2 (a). The conclusion for this scenario can be that the team is performing great, but needs to improve KRMC to its maximum limit.
c. If ΣMS trend is downward (↓) for a time frame within these two months, KRM still increases (↑). The KRMC trend goes upward (↑) and KRM increases (↑) when less number of skills (ΣMS) is required; this indicates that the project has less risk as compared with the risk indicated in Case 1, but has a higher risk as compared with the risk indicated in Case 2(a & b). Although the team is performing satisfactory and there is less risk, there may be chances that the risk may increase if the project manager is not careful.

From the above mentioned Case 2, it is evident that the team performance is good and the project has less risk, when KRM increases (↑) and the KRMC trend show an upward (↑) trend. Similar to Case 1, the level of team performance and the extent of risk to the project are determined on the basis of the ΣMS trend.

Case 3: When the KRMC trend is constant ( [symbol] ) for the first two months:

a. If the ΣMS trend is constant ( [symbol] ) for a time frame within these two months, KRM remains constant ( [symbol] ). The KRMC trend and KRM remain are constant ( [symbol] ) when same number of skills (ΣMS) is required; this indicates that the project has same risk as that in the previous instance. For this scenario, it can be concluded that the team is performing well, but need to improve KRMC to its maximum limit.
b. If the ΣMS trend is in an upward (↑) direction for a time frame within these two months, KRM increases (↑). KRMC trend is constant ( [symbol] ) and KRM increases (↑) when a higher number of skills (ΣMS) are required; this indicates that the project has same risk as in Case 2(a). For this scenario, it can be concluded that the team is performing well, but needs to improve. Also, in this scenario the project has less risk as compared with that of Case 3(a).
c. If the ΣMS trend is downward (↓) for a time frame within these two months, KRM decreases (↓). The KRMC trend is constant ( [symbol] ) and KRM decreases (↓) when a lesser number of skills (ΣMS) are required; this indicates that the project has the same risk as in Case 1(b), and it is recommended to enhance the existing skill value for the team. Also, in this scenario the project has a higher risk as compared with that of Case 3(a & b).

For the above mentioned Case 3, it is evident that when KRMC shows a constant ( [symbol] ) trend, the ΣMS trend has a high impact on KRM.

It should be appreciated by a person skilled in the art that there can be various other scenarios for KRM, KRMC, and MS trend than those described above. The above cases have been provided purely for the purpose of understanding and should in no way be limiting to the scope of the invention.

FIG. 3 is a flowchart illustrating a method for calculating KRMC at an instance of time, of a team executing a project, in accordance with an embodiment of the invention.

At 302, a team comprising “x” number of members are selected for executing a project. Thereafter, the existing skill value for x^{th} team member is identified at an instance of time t at 304. At 306, the number of skills possessed by the team (TC) is calculated at t on the basis of the existing skill value for each of the x team members. In an embodiment of the invention, TC may be calculated by combining the existing skill value for x number of team members. Further, the number of skills required by the x^{th} team member to execute the project is identified at time instance t at 308. Subsequently, at 310, the number of skills required by the team (MS) is calculated for the instance of time t on the basis of the number of skills required by each of the x team members to execute the project. In an embodiment of the invention, MS could be calculated by combining the number of skills required by x team members. Finally at 312, KRMC is calculated for the same instance of time t using TC and MS defined at 306 and 310, respectively. In an embodiment of the invention, KRMC at instance t may be calculated by using the following formula:

KRMC=ΣTC_{1 . . . x}/ΣMS_{1 . . . x}

KRMC are calculated for different instances of time, i.e., t₁, t₂ . . . tₙ, by the method illustrated in FIG. 3 and the set of these calculated KRMC are provided to trend module 108 shown in FIG. 1 to identify the KRMC trend for a duration of time T, where T is

T=t₁+t₂+ . . . +tₙ

The invention thus provides a method and system for evaluating KRM for a team executing a project. The knowledge risk maturity of the team is evaluated on the basis of ΣMS and KRMC. The extent of risk to the project is assessed by KRM of the team. It defines the degree of risk associated with the project on the basis of team performance at an instance of time. Precise corrective measures can be taken on the basis of the risk associated with the project to enhance KRMC for the next instance of time. Such timely measures can help in achieving a high-quality output for the project.

The invention also provides a method and system for calculating KRMC of a team. KRMC is calculated on the basis of the existing skill value for the team and the skills required for executing the project. KRMC is a quantified measure of the performance of a team executing a project at any instance of time. Corrective measures could be taken on the basis of KRMC for enhancing the knowledge availability of the team and consecutively enhancing the quality of the output of the project at next instances of time.

The KRM system for determining KRM associated with a team executing a project, as described in the present invention or any of its components may be embodied in the form of a computer system. Typical examples of a computer system include a general-purpose computer, a programmed microprocessor, a micro-controller, a peripheral integrated circuit element, and other devices or arrangements of devices capable of implementing the steps that constitute the method of the present invention.

The computer system comprises a computer, an input device, a display unit, and a network interface module for connecting with the Internet. The computer further comprises a microprocessor. The microprocessor is connected to a communication bus. The computer also includes a computer usable medium such as a memory. The memory may include Random Access Memory (RAM) and Read Only Memory (ROM). The computer system further comprises a storage device. The storage device can be a hard disk drive or a removable storage drive such as a floppy disk drive and optical disk drive. The storage device can also be other similar means for loading computer readable program codes or other instructions into the computer system. The computer system also includes a communication unit. The communication unit allows the computer to connect to other databases and the Internet through an I/O interface. The communication unit allows the transfer and the reception of data from other databases. The communication unit may include a modem, an Ethernet card, or any similar device which enables the computer system to connect to databases and networks such as LAN, MAN, WAN, and the Internet. The computer system facilitates inputs from a user through input device, accessible to the system through I/O interface.

The computer system executes a set of instructions or computer readable program codes that are stored in one or more computer usable storage elements to process input data. The storage elements may also hold data or other information as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. Further, the software may be in the form of a collection of separate programs, a program module with a larger program, or a portion of a program module, as in the present invention. The software may also include modular programming in the form of object-oriented programming. The processing of input data by the processing machine may be in response to user commands, results of previous processing, or a request made by another processing machine.

While the preferred embodiments of the invention have been illustrated and described, it will be clear that the invention is not limited to these embodiments only. Numerous modifications, changes, variations, substitutions, and equivalents will be apparent to those skilled in the art without departing from the spirit and scope of the invention as described in the claims.

1. A method for evaluating knowledge risk maturity of a team executing a project, the method comprising:
identifying a knowledge risk maturity coefficient trend for the project during a time frame;
analyzing a skill-requirement trend achieved by the team in executing the project during the time frame;
comparing the knowledge risk maturity coefficient trend and the skill-requirement trend to identify an extent of risk to the project; and
determining corrective measures based on the extent of risk to improve knowledge risk maturity of the project.

2. The method according to claim 1, wherein the team comprises one or more resources.

3. The method according to claim 1, wherein analyzing the skill-requirement trend achieved by the team comprises comparing present number of skills required by the team to execute the project with previously required number of skills by the team to execute the project during the time frame.

4. The method according to claim 1, wherein identifying a knowledge risk maturity coefficient trend for the project during a time frame comprises:
identifying an existing skill value of the team;
identifying number of skills required for the project;
calculating a knowledge risk maturity coefficient using the existing skill value and the number of skills; and
comparing the knowledge risk maturity coefficient with a previously obtained knowledge risk maturity coefficient to identify the knowledge risk maturity coefficient trend.

5. The method according to claim 1, wherein comparing the knowledge risk maturity coefficient trend and the skill-requirement trend to identify the extent of risk comprises identifying a knowledge risk maturity using the knowledge risk maturity coefficient trend and the skill-requirement trend.

6. The method according to claim 5, wherein identifying the extent of risk comprises comparing the knowledge risk maturity with previously obtained knowledge risk maturity.

7. A system for evaluating knowledge risk maturity of a team executing a project, the system comprising:
a calculator for calculating knowledge risk maturity coefficients;
a trend module for identifying a knowledge risk maturity coefficient trend based on the calculated knowledge risk maturity coefficients;
an analyzer for analyzing a skill-requirement trend achieved by the team to execute the project; and
a comparator for comparing knowledge risk maturity coefficient trend and the skill-requirement trend to identify a knowledge risk maturity.

8. The system of claim 7, wherein the calculator comprises:
a first identifier for identifying an existing skill value of the team;
a second identifier for identifying number of skills required for the project; and
a calculating unit for calculating the knowledge risk maturity coefficient based on the existing skill value and the number of skills required for the project.

9. The system of claim 7 further comprising an input unit for providing the existing skill value of the team and the number of skills required for the project as input to the calculator and to the analyzer.

10. The system of claim 7 further comprising a display unit for displaying at least one of the knowledge risk maturity coefficients, the knowledge risk maturity coefficient trend, the existing skill value for the team, the number of skills required for the project, the skill-requirement trend and the knowledge risk maturity.

11. A computer program product for use with a computer, the computer program product comprising a computer usable medium having a computer readable program code embodied therein for evaluating knowledge risk maturity of a team executing a project, the computer readable program code performing:
identifying a knowledge risk maturity coefficient trend for the project during a time frame;
analyzing a skill-requirement trend achieved by the team in executing the project during the time frame; and
comparing the knowledge risk maturity coefficient trend and the skill-requirement trend to identify an extent of risk to the project, wherein the identified extent of risk to the project facilitates determination of corrective measures for improving the knowledge risk maturity of the project.

12. The computer program product according to claim 11, wherein the computer readable program code performing analyzing the skill-requirement trend achieved by the team comprises comparing present number of skills required by the team to execute the project with previously required number of skills by the team to execute the project during the time frame.

13. The computer program product according to claim 11, wherein the computer readable program code performing identifying a knowledge risk maturity coefficient trend for the project during a time frame comprises:
identifying an existing skill value of the team;
identifying number of skills required for the project;
calculating a knowledge risk maturity coefficient using the existing skill value and the number of skills; and
comparing the knowledge risk maturity coefficient with a previously obtained knowledge risk maturity coefficient to identify the knowledge risk maturity coefficient trend.

14. The computer program product according to claim 11, wherein the computer readable program code performing comparing the knowledge risk maturity coefficient trend and the skill-requirement trend to identify the extent of risk comprises identifying a knowledge risk maturity using the knowledge risk maturity coefficient trend and the skill-requirement trend.

15. The computer program product according to claim 14, wherein the computer readable program code performing identifying the extent of risk comprises comparing the knowledge risk maturity with previously obtained knowledge risk maturity.
